(19) United States
(12) Patent Application Publication
(10) Pub. No.: US 2007/0086601 A1
(43) Pub. Date: Apr. 19, 2007

(54) Flexible wireless air interface system

(76) Inventor: Dennis W. Mitchler, Kanata (CA)

Correspondence Address: STEPHEN D. SCANLON, JONES DAY, 901 LAKESIDE AVENUE, CLEVELAND, OH, 44114, US

(21) Appl. No.: 11/581,702

(22) Filed: Oct. 16, 2006

Related U.S. Application Data
(60) Provisional application No. 60/727,292, filed on Oct. 17, 2005.

(51) Int. Cl. H04B 5/00; H04R 25/00

(52) U.S. Cl. 381/79; 381/315

(57) ABSTRACT

A flexible air interface is provided. The air interface may include a frame synchronization word field to delineate the start of a frame structure, an out-of-band message channel field allowing a low speed communication link between a plurality of processors attached to wireless devices, and a configurable payload field to carry main payload information. In addition, the air interface may support a plurality of modes, including a first mode providing unidirectional communication to transport audio samples, a second mode providing bidirectional communication to transport audio samples, a third mode providing bidirectional communication to transport data, and a fourth mode providing bidirectional communication to provide low-power data communication.

### CROSS-REFERENCE TO RELATED APPLICATION

This application claims priority from U.S. Provisional Application No. 60/727292, filed on Oct. 17, 2005, the entirety of which is incorporated herein by reference.

### TECHNICAL FIELD

This technology relates to communication protocols.

### BACKGROUND

Typical air interfaces are limited to one type of application or require a significant overhead to achieve flexibility. This overhead increases power requirements as more non-payload data needs to be transported. Further, for audio applications, using these typical air interfaces is costly in terms of latency. For example, many existing air interfaces may be limited to data transport, may have fixed frame lengths, or may have significant overhead for framing and set up. It would be advantageous to provide an air interface that facilitates the transmission of both audio and data payloads, facilitates a large variety of payload rates and/or minimizes framing overhead.

### SUMMARY

A wireless hearing instrument system includes a base unit with one or more microphones for generating a signal and communications circuitry for wirelessly transmitting the signal. The system also includes a hearing instrument with communications circuitry for receiving the signal from the base unit, where the hearing instrument is operable to process the signal to compensate for a hearing impairment of a hearing instrument user and to transmit the processed audio signal into an ear canal of the hearing instrument user.

The communications circuitry for wireless transmitting the signal includes a memory for storing data that includes a frame synchronization word field to delineate the start of a frame structure, an out-of-band message channel field that allows a low speed communication link between a plurality of processors attached to wireless devices, and a configurable payload field that carries main payload information.

The communications circuitry is also configured to transmit data in a plurality of modes. A first mode provides unidirectional communication to transport audio samples. A second mode provides bidirectional communication to transport audio samples. A third mode provides bidirectional communication to transport data, and a fourth mode provides bidirectional communication to provide low-power data communication.

### BRIEF DESCRIPTION OF THE DRAWINGS

FIG. 1 is a block diagram of a hearing instrument having a wireless base unit.

FIG. 2 illustrates a base unit in wireless communication with a plurality of hearing instruments.

FIG. 3 illustrates a wireless communication between two binaural hearing instruments.

FIG. 4 illustrates a user interface device in wireless communication with a hearing instrument.

FIG. 5 illustrates a user interface device in wireless communication with a base unit.

FIG. 6 is a block diagram of an example base unit.

FIG. 7 is a block diagram of an example hearing instrument.

FIG. 8 is a block diagram of an example hearing instrument showing a more-detailed example of communications circuitry.

FIG. 9 is a functional diagram of an example baseband processor.

FIG. 10 is an example of a basic frame structure for a flexible air interface protocol.

FIG. 11 is an example frame structure without error control.

FIG. 12 is an example frame structure for a flexible air interface protocol with a cycle redundancy check (CRC) check-sum error protection scheme.

FIG. 13 is an example frame structure for a flexible air interface protocol with a Hamming-based error correction scheme.

FIG. 14 is an example frame structure for a flexible air interface protocol with a Hamming-based error correction scheme and a CRC.

FIG. 15 is an example timing diagram for a transmission using the unidirectional audio mode in an example flexible air interface protocol.

FIG. 16 is an example timing diagram for a bidirectional audio mode in the example flexible air interface protocol.

FIG. 17 is an example timing diagram for a bidirectional data mode in the example flexible air interface protocol.

FIG. 18 is an example timing diagram 300 for a low-power bidirectional data mode in the example flexible air interface protocol.

### DETAILED DESCRIPTION

The elements shown in the drawings include examples of the structural elements recited in the claims. The illustrated elements thus include examples of how a person of ordinary skill in the art can make and use the claimed invention. They are described here to provide enablement and best mode without imposing limitations that are not recited in the claims.

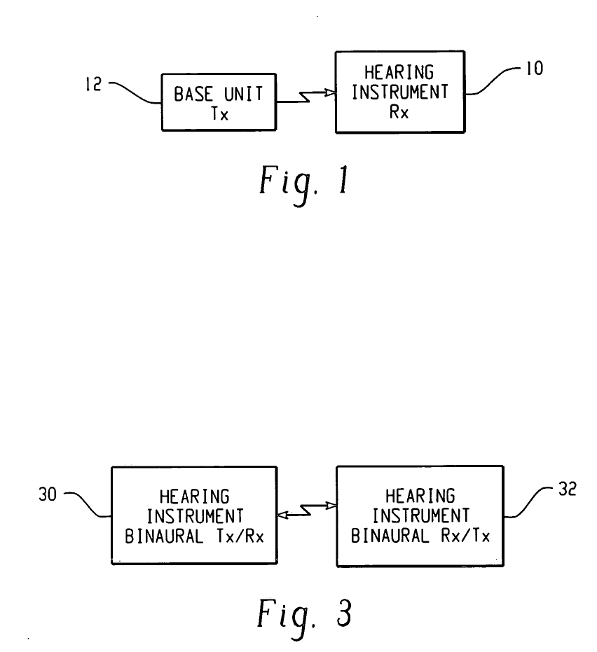

FIG. 1 is a block diagram of a hearing instrument 10 having a wireless base unit 12. The base unit 12 may include one or more microphones for receiving an audio signal and communications circuitry for wirelessly transmitting the audio signal to the hearing instrument 10. The hearing instrument 10 may include communications circuitry for receiving the audio signal from the base unit 12. The hearing instrument 10 may further include a processing device operable to process the audio signal to compensate for a hearing impairment of a hearing instrument user and a speaker for transmitting the processed audio signal into an ear canal of the hearing instrument user.

The base unit 12 may be a hand held device having one or more microphones to receive audio signals, for example from nearby talkers. The base unit 12 may then convert the received audio signals into the digital domain, process the digital signals, modulate the processed signals to an RF carrier and transmit the signals to the hearing instrument 10. The base unit 12 may include an integral processing device, such as a digital signal processor (DSP), for processing received signals. For example, the base unit 12 may perform directional processing functions, audio compression functions, clear channel searching functions, or other signal processing functions.

In addition to transmitting audio signals to the hearing instrument, the base unit 12 may also transmit and receive other data, such as control data. For example, the base unit 12 may receive control data from a user interface to configure parameters, such as frequency channel and operational modes. In addition, control data may be transmitted from the base unit 12 to the hearing instrument 10, for example to program the hearing instrument. In another example, the communication link between the hearing instrument 10 and the base unit 12 may be bi-directional. Bi-directional communication between the hearing instrument 10 and the base unit 12 may be used to transmit data between the devices 10, 12, such as programming data, data uploads/downloads, binaural communication, or other applications. In one example, the base unit 12 may function as a wireless links to an external device or network, such as a computer network, a, CD player, a television, a cellular telephone, or others. For instance, the base unit 12 may receive an input (wired or wireless) from the external device or network and function as a wireless gateway between the device or network and the hearing instrument 10.

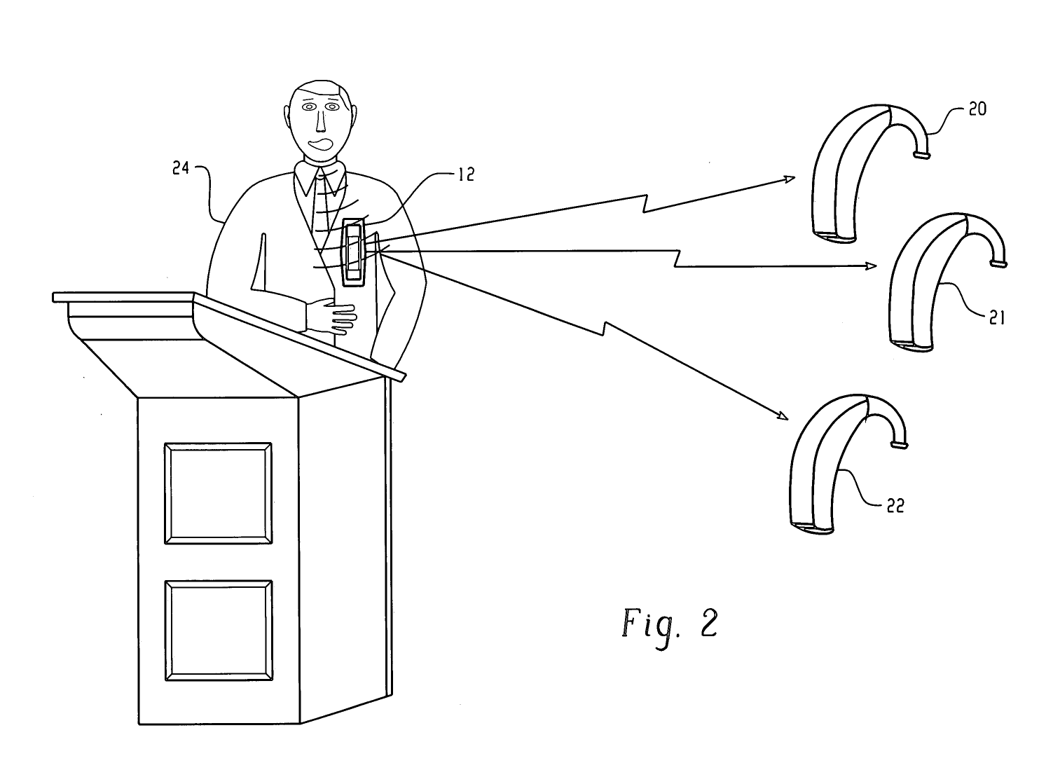

As illustrated in FIG. 2, the base unit 12 may be positioned to receive audio signals at a distance from the hearing instrument user. In addition, the base unit 12 may be configured to transmit received audio signals and/or other data to a single hearing instrument or to a plurality of hearing instruments 20-22. In the illustrated example, the base unit 12 is positioned in the vicinity of a speaker 24, for example in the speaker's pocket or on a surface near the speaker, and the audio signals received by the base unit 12 are wirelessly transmitted to a plurality of hearing instruments 20-22. For example, a plurality of hearing instrument users may each have wireless access to the same base unit 12. In this manner, a speaker 12 may use a single base unit 12 to communicate with a number of hearing impaired listeners. In another example, the base unit 12 may transmit audio signals to two hearing instruments 20, 21 worn by a single hearing instrument user (e.g., one in each ear.) In the case of a hearing instrument user having two hearing instruments 30, 32, the communications circuitry in the hearing instrument may also be used to transmit audio signals and/or other data between the two hearing instruments 30, 32, as illustrated in FIG. 3. For example, when used with binaural fittings, a wireless communications link between hearing instruments 30, 32 may be used to synchronize the two hearing instruments.

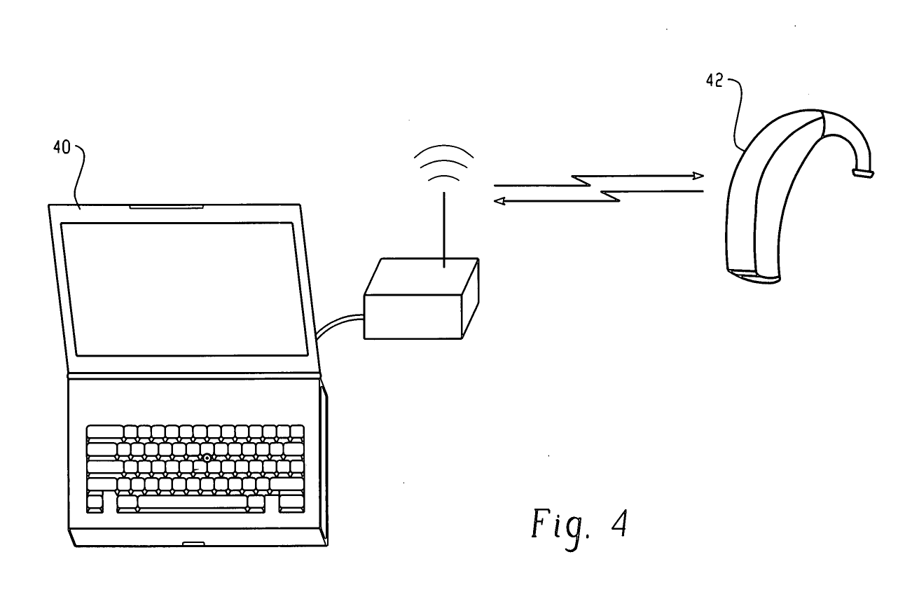

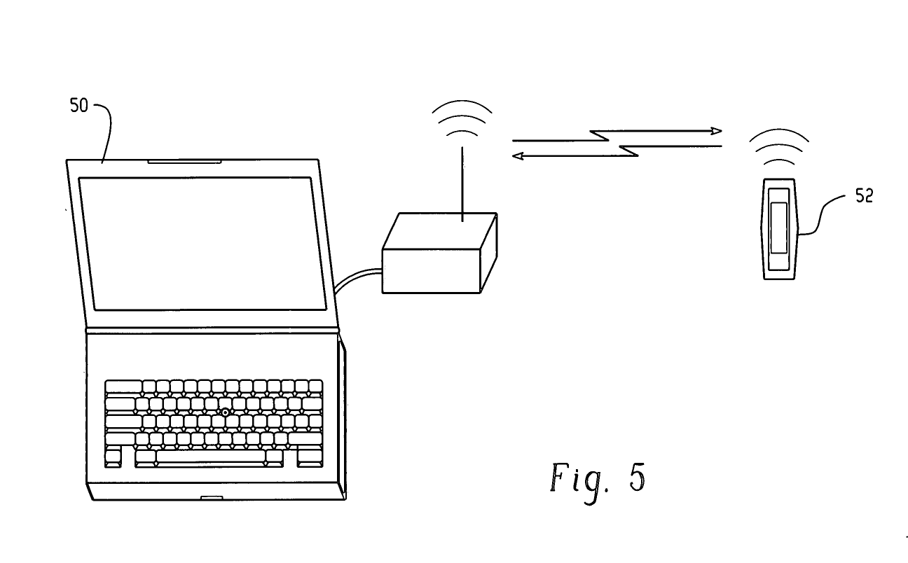

The wireless communications circuitry in the hearing instrument and/or base unit may also be used to communicate with a user interface device 40, 50, as illustrated in FIGS. 4 and 5. FIG. 4 illustrates a user interface device 40 in wireless communication with a hearing instrument 42. FIG. 5 illustrates a user interface device 50 in wireless communication with a base unit 52. The wireless links between the user interface 40, 50 and the hearing instrument 42 and/or base unit 52 may be either single- or bi-directional. The user interface 40, 50 may be a desktop or laptop computer, a hand-held device, or some other device capable of wireless communication with the hearing instrument 42 and/or base unit 52. The user interface 40, 50 may be used to wirelessly program and/or control the operation of the hearing instrument 42 and/or base unit 52. For example, a user interface 40 may be used by an audiologist or other person to program the hearing instrument 42 for the particular hearing impairment of the hearing instrument user, to switch between hearing instrument modes (e.g., bi-directional mode, omni-directional mode, etc.), to download data from the hearing instrument, or for other purposes. In another example, the user interface 40, 50 may be used to select the frequency channel and/or frequency band used for communications between the hearing instrument 42 and base unit 52. In addition, the base unit 52 functionality may be embedded as a part of a larger system, such as a cellular telephone, to enable direct communication to a hearing instrument.

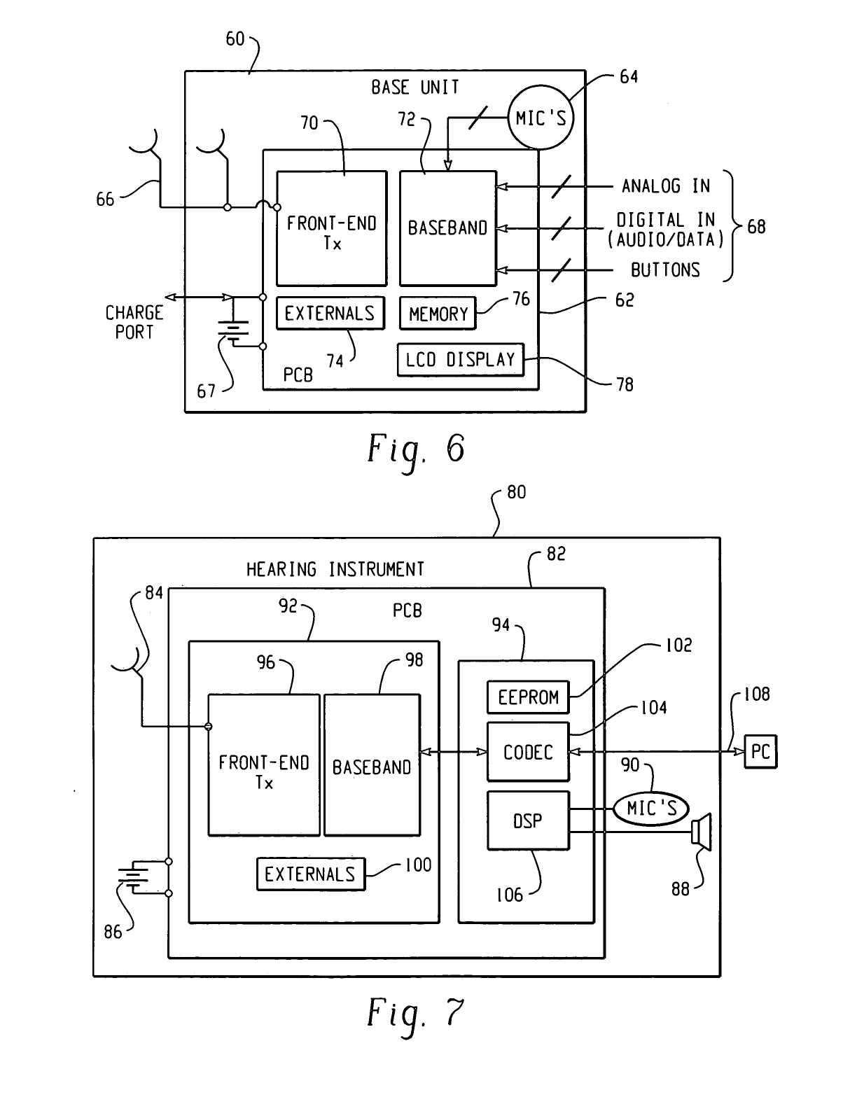

FIG. 6 is a block diagram of an example base unit 60. The base unit 60 includes a printed circuit board (PCB) 62, one or more microphones 64, an antenna 66, a battery 67 and a plurality of inputs 68. The PCB 62 includes communications circuitry 70, a baseband processor 72, external components 74 (e.g., resistive and reactive circuit components, oscillators, etc.), a memory device 76 and an LCD 78. As illustrated, the communications circuitry 70 and the baseband processor 72 may each be implemented on an integrated circuit, but in other examples may include multiple integrated circuits and/or other external circuit elements. The inputs 68 include an analog input, a digital input, and one or more external input devices (e.g., a trimmer, a pushbutton switch, etc.) The analog input may, for example, include a stereo input from a television, stereo or other external device. The inputs 68 may also include wired or wireless inputs, such as a Bluetooth link or other wireless input/output. The antenna 66 may be an internal antenna or an external antenna, as illustrated. Also illustrated is a charge port for charging the battery 67.

In operation, the base unit receives audio signals with the one or more microphones 64 and converts the audio signals into the digital domain for processing by the baseband processor 72. The baseband processor 72 processes the audio signals for efficient wireless transmission, and the processed audio signals are transmitted to the hearing instrument by the communications circuitry 70. In this manner, the received audio signals from the microphone(s) 64 may be digitized near the source of the sound, with further processing and transmission performed in the digital domain and the final digital to analog conversion occurring in the hearing instrument. In addition, the base unit 72, using the built-in communications circuitry and RF signal strength detection, may automatically select a clear frequency channel for low-noise communication with the hearing instrument.

The communications circuitry 70 may include both transmitter and receiver circuitry for bi-directional communication with a hearing instrument or other wireless device. In one example, the frequency channel and/or the frequency band (e.g., UHF, ISM, etc.) used by the communications circuitry may be programmable. In other examples, the communications circuitry 70 may include multiple occurrences of transmitter and receiver circuitry. This these cases the single antenna may be preceded by an RF combiner and impedance matching network. In addition, the communications circuitry 70 may be operable to communicate on multiple channels to support functions such as stereo transmission, multi-language transmission, or others. For example, the communications circuitry 70 may transmit stereo audio to a set or binaural hearing instruments on two channels, one channel for each hearing instrument. The stereo signal may, for example, be synchronized at the base unit 60, or in another example may be synchronized using binaural communications between the two hearing instruments. A more detailed diagram of communications circuitry that may be used in the base unit 60 is described below with reference to FIG. 8.

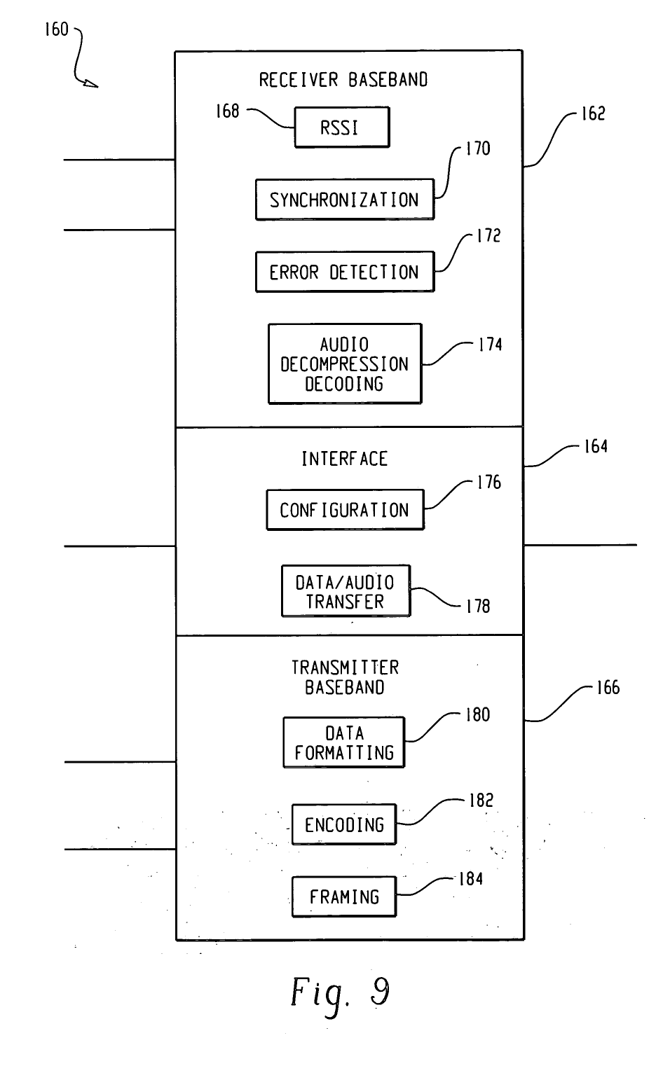

The baseband processor 72 is a digital signal processor (DSP) or other processing device(s), and is operable to perform baseband processing functions on audio signals received from the microphones 64 or other audio inputs 68 (e.g., CD player, television, etc.), such as audio compression, encoding, data formatting, framing, and/or other functions. Also, in the case of a bi-directional system, the baseband processor 72 may perform baseband processing functions on received data, such as audio decompression and decoding, error detection, synchronization, and/or other functions. In addition to baseband processing functions, the baseband processor 72 may perform processing functions traditionally performed at the hearing instrument, such as directional processing, noise reduction and/or other functions. An example baseband processor is described in more detail below with reference to FIG. 9.

The baseband processor 72 may also execute a program for automatically selecting a clear frequency channel for low-noise communication with the hearing instrument. For example, a clear channel selection program executed by the baseband processor 72 may cause the communications circuitry 70 to sweep through the operating frequency band to identify a quiet frequency channel, and then set the communication circuitry 70 to operate using the identified quiet channel. A clear channel may be selected, for example, by measuring a noise level at each frequency in the band, and then selecting the frequency channel with the lowest noise level. In another example, the clear channel selection program may only sweep through frequencies in the operating band until a frequency channel is identified having a noise level below a pre-determined threshold, and then set the communications circuitry 70 to operate using the identified channel. A frequency band sweep may be initiated, for example, by a user input (e.g., depressing a button 68), by detecting that the noise level of a currently selected channel has exceeded a pre-defined threshold level, or by some other initiating event. The noise level of a channel may, for example, be measured by the an RSSI process in the baseband processor 72 (see, e.g., FIG. 9), by a frequency synthesizer and channel signal strength detector included in the communications circuitry, or by some other means. For the purposes of this patent document, the noise level of a communication channel may include environmental noise, cross-talk from other channels, and/or other types of unwanted disturbances to the transmitted signal.

In another example, the baseband processor 72 may also be used to set the operating frequency band used by the communications circuitry 70. For example, the operating frequency band may be set to unused UHF bands, regulated bands for wireless microphones, or other frequency bands available for wireless communication. The operating frequency band may, for example, be set by a user input 68 or by the clear channel selection program. For example, if a clear frequency channel is not identified by the clear channel selection program in an initial band, then a new operating frequency band may be selected either automatically or by user input.

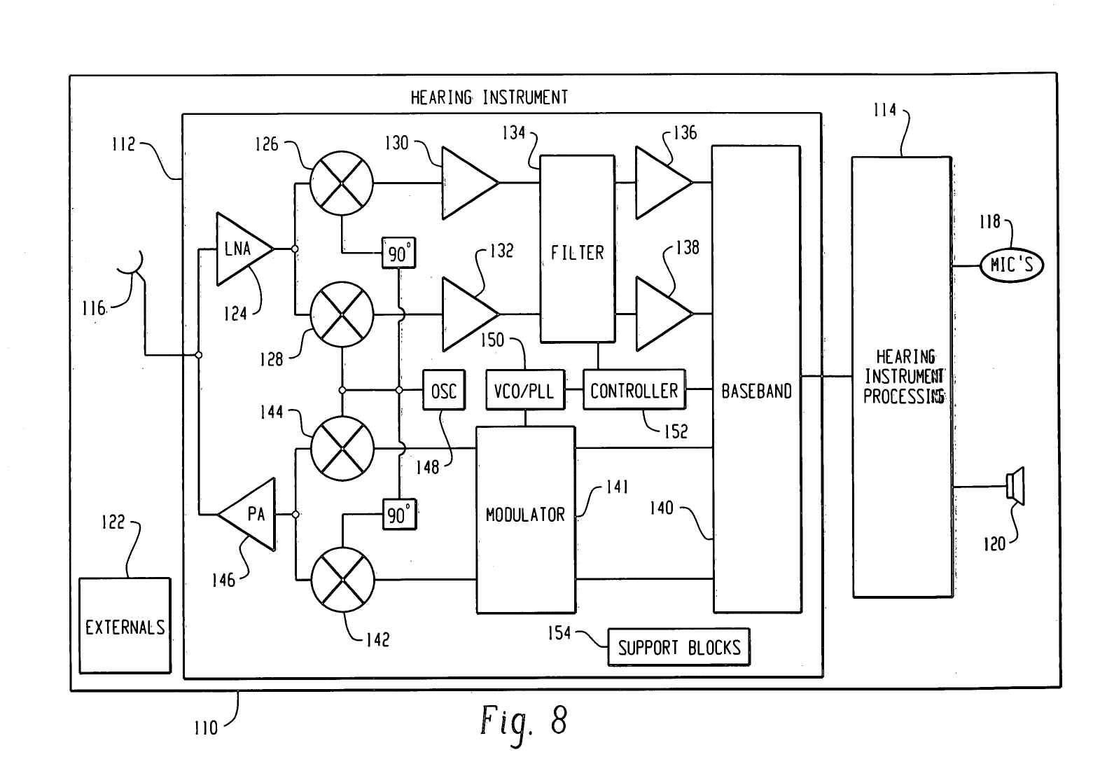

FIG. 7 is a block diagram of an example hearing instrument 80. The hearing instrument 80 includes a hearing instrument circuit 82, an antenna 84, a battery 86, a speaker 88, and one or more microphones 90. The hearing instrument 80 may also include one or more input devices, such as volume control, mode selection button, or others. The hearing instrument circuit 82 includes a RF communication module 92 and a hearing instrument module 94, which may be arranged on a printed circuit board, a thin film circuit, a thick film circuit, or some other type of circuit that may be sized to fit within a hearing instrument shell. In one additional example, the RF communication module 92 may be included in an external attachment to the hearing instrument 80. The antenna 84 may be a low-power miniature antenna, such as the antenna described in the commonly-owned U.S. patent application Ser. No. ______, entitled “Antenna For A Wireless Hearing Aid System,” which is incorporated herein by reference.

The RF communication module 92 includes communications circuitry 96, a baseband processor 98 and externals components 100 (e.g., resistive and reactive circuit components, oscillators, etc.) As illustrated, the communications circuitry 96 and the baseband processor 98 may each be implemented on an integrated circuit, but in other examples may include multiple integrated circuits and/or external circuit elements. The communications circuitry 96 may be the same as the communications circuitry 70 in the base unit 60 in order to better ensure compatibility.

The communications circuitry 96 may include both transmitter and receiver circuitry for bi-directional communication with the base unit 60. In addition, bi-directional communications circuitry 96 may be used to communicate with another hearing instrument (e.g., in a binaural fitting) and/or with other wireless devices. The communications circuitry 96 may also be programmable to select an operating frequency channel and/or frequency band. For example, in the case of a clear channel selection program executing on the base unit 60, as described above, the communications circuitry 96 may receive a control signal from the base unit 60 to change operating frequencies or bands. In another example, the clear channel selection program may instead execute on a processor in the hearing instrument, such as the baseband processor 98.

The baseband processor 98 may be a DSP or other processing device, and performs baseband processing functions on the received audio signal, such as audio decompression and decoding, error detection, synchronization, and/or other functions. The baseband processor 98 may also perform baseband processing functions on outgoing transmissions, such as audio compression and encoding, data formatting and framing, and/or other functions. In addition, the baseband processor 98 may perform other processing functions to interface the RF module 82 with the hearing instrument module 84.

The hearing instrument module 94 includes a memory device 102, a CODEC 104, and a hearing instrument processor 106. The memory device 102 may be a EEPROM or other type of persistent memory device. The memory device 102 may be used to store hearing instrument settings, record hearing instrument parameters, or for other data storage. The CODEC 104 may be used to interface the hearing instrument module 94 with the baseband processor 98 and with external devices (e.g., an audiologist's PC or other computing device) via an external serial port 108. The hearing instrument processor 106 is operable to process audio signals received from the base unit or from the hearing instrument microphone(s) 90 to compensate for the hearing impairments of a hearing instrument user and transmit the processed audio signal into the ear canal of the hearing instrument user via the speaker 88. The hearing instrument processor 106 may also perform other signal processing functions, such as directional processing, occlusion cancellation and/or other digital hearing instrument functions. An example hearing instrument processor 106 that may be used in the system described herein is set forth in the commonly-owned U.S. patent application Ser. No. 10/121,221, entitled “Digital Hearing Aid System.” FIG. 8 is a block diagram of an example hearing instrument 110 showing a more-detailed example of communications circuitry. The example communications circuitry illustrated in FIG. 8 may also be used in a base unit, such as the example base unit 60 shown in FIG. 6. The example hearing instrument 110 includes an RF communication module 112, a hearing instrument processor 114, an antenna 116, one or more hearing instrument microphones 118, a hearing instrument speaker 120 and one or more externals components 122 (e.g., resistive and reactive circuit components, filters, oscillators, etc.) As illustrated, the RF communication module 112 and the hearing instrument processor 114 may each be implemented on a single integrated circuit, but in other examples could include multiple integrated circuits and/or external circuit components.

The RF communication module 112 includes a baseband processor 140 and communications circuitry. The communications circuitry includes a transmit path and a receive path. The receive path includes a low noise amplifier (LNA) 124, a down conversion quadrature mixer 126, 128, buffering amplifiers 126, 128, an I-Q image reject filter 134 and a slicer 136, 138. The transmit path includes a modulator 141, an up conversion quadrature mixer 142, 144 and a power amplifier 146. The receive and transmit paths are supported and controlled by the baseband processor 140 and clock synthesis circuitry 148, 150, 152. The clock synthesis circuitry includes an oscillator 148, a phase locked loop circuit 150 and a controller 152. The oscillator 148 may, for example, use an off chip high Q resonator (e.g., crystal or equivalent) 122. The frequency of the phase locked loop circuit 150 is set by the controller 152, and controls the operating frequency channel and frequency band. The controller 152 may, for example, be accessed by a clear channel selection program, as described above, to select the operating frequency channel and/or frequency band of the system. Also included in the RF communication module 112 are support blocks 154, which may include voltage and current references, trimming components, bias generators and/or other circuit components for supporting the operation of the transceiver circuitry.

In operation, an RF signal received by the antenna 116 is amplified by the LNA 124, which feeds the down conversion mixer 126, 128 to translate the desired RF band to a complex signal. The output of the down conversion mixer 126, 128 is then buffered 130, 132, filtered by the image reject filter 134 and slicer 136, 138 and input to the baseband processor 140. The baseband processor 140 performs baseband processing functions, such as synchronizing the incoming data stream, extracting the main payload and any auxiliary data channels (RSSI and AFC information), and performing necessary error detection and correction on the data blocks. In addition, the baseband processor 140 decompresses/decodes the received data blocks to extract the audio signal, for example as a standard I2S output.

Outgoing audio and/or control signals may be encoded and formatted for RF transmission by the baseband processor 140. In the case of outgoing audio signals, the baseband processor 140 may also perform audio compression functions. The processed signal is modulated to an RF carrier by the modulator 141 and up conversion mixer 142, 144. The RF signal is then amplified by the power amplifier 146 and transmitted over the air medium by the antenna 116.

FIG. 9 is a functional diagram of an example baseband processor 160. The example baseband processor 160 may, for example, be used in the hearing instrument and/or base unit. The baseband processor 160 may perform receiver baseband processing functions 162, interface functions 164 and transmitter baseband processing functions 166. The illustrated baseband processor 160 includes two receiver inputs, two interface input/outputs, and two transmitter outputs, corresponding to the input/outputs to the baseband processor 140 shown in FIG. 8. It should be understood, however, that other input/output configurations could be used.

The receiver baseband processing functions 162 include signal level baseband functions 168, 170, such as a synchronization function 170 to synchronize with the incoming data stream, and a data extraction function 168 for extracting the payload data. Also included in the receiver functions 162 are an error detection function 172 for detecting and correcting errors in the received data blocks, and an audio decompression decoding function 174 for extracting an audio signal from the received data blocks.

The transmitter baseband processing functions 166 include data formatting 180 and framing 184 functions for converting outgoing data into an RF communication protocol and an encoding function 182 for error correction and data protection. The RF communication protocol may be selected to support the transmission of high quality audio data as well as general control data, and may support a variable data rate with automatic recognition by the receiver. The encoding function 182 may be configurable to adjust the amount of protection based on the content of the data. For example, portions of the data payload that are more critical to the audio band from 100 Hz to 8 kHz may be protected more than data representing audio from 8 kHz to 16 kHz. In this manner, high quality audio, although in a narrower band, may still be recovered in a noisy environment. In addition, the transmitter baseband processing functions 166 may include an audio compression function for compressing outgoing audio data for bandwidth efficient transmission.

The interface functions 164 include a configuration function 176 and a data/audio transfer function 178. The data/audio transfer function 178 may be used to transfer data between the baseband processor 160 and other circuit components (e.g., a hearing instrument processor) or external devices (e.g., computer, CD player, etc.) The configuration function 176 may be used to control the operation of the communications circuitry. For example, the configuration function 176 may communicate with a controller 152 in the communications circuitry to select the operating frequency channel and/or frequency band. In one example, the configuration function 176 may be performed by a clear channel selection program, as described above, that identifies a low noise channel and/or frequency band and sets the operating parameters of the communication circuitry accordingly.

Returning briefly to FIG. 1, in one embodiment there are at least two nodes in the system, a master node and a slave node. In this example, the base unit 12 may be the master node, and the hearing unit 10 may be the slave node. The master node 12 provides a system clock reference for all of the nodes in the wireless system. The slave node 10 can lock its timing based on data sent by the master node 12. A link originating from a transmitter on the master node 12 and sent to a receiver on the slave node 10 is a forward link. Alternatively, a link originating from a transmitter on the slave node 10 and sent to a receiver on the master node 12 is called the reverse link.

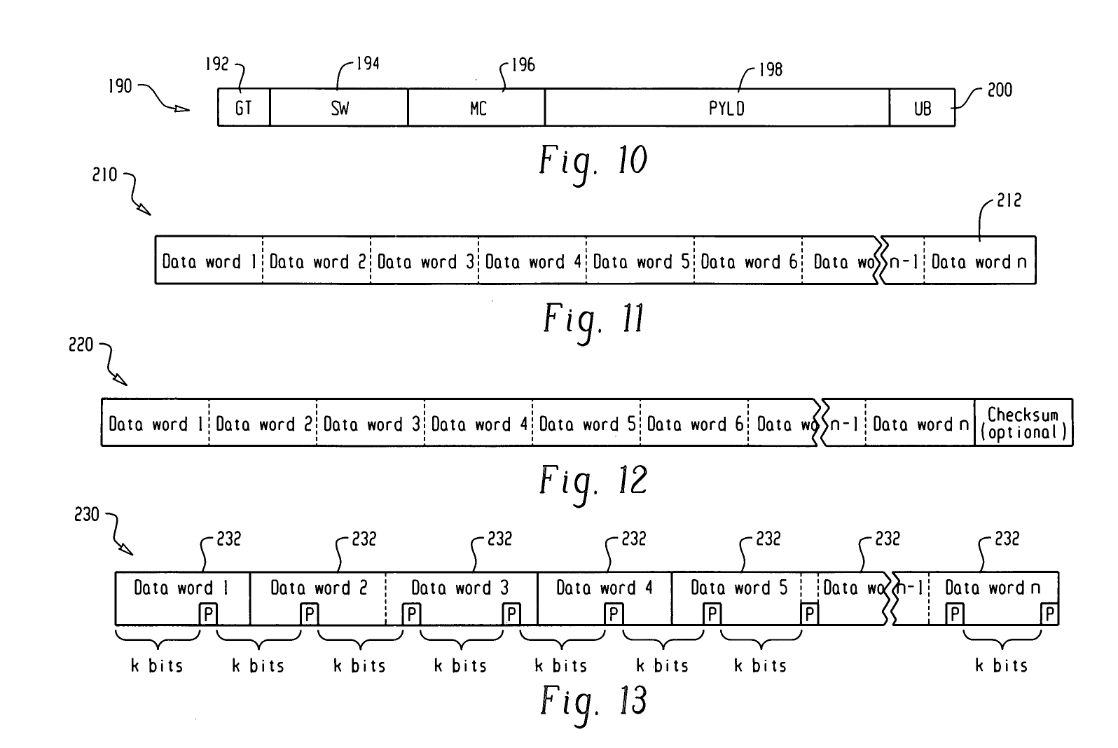

FIG. 10 is an example of a basic frame structure 190 for a flexible air interface protocol. The frame 190 includes three main fields: a frame synchronization word (SW) field 194, an out-of-band message channel (MC) field 196 and a configurable payload (PYLD) field 198. The frame 190 also includes two additional fields, a guard time (GT) field 192 and an unused bits (UB) field 200.

The SW field 194 can be a 16-bit frame synchronization word, and is used to delineate the start of the frame structure 190. The SW field 194 values may be programmable. The synchronization process involves the receiver finding a number of valid sync words before establishing frame synchronization. The number of valid sync words can be programmable. The larger the number of words, the more robust the synchronization process is to transmission errors. In one embodiment, there is a programmable number of errors in the SW field 194 that indicate the number of errors that must occur before synchronization is lost. Once frame synchronization is established, data extracted from the PYLD field 198 is available to the rest of the system to which the frame 190 was directed.

The MC field 196 can be a 16-bit out-of-band message channel (MC) field that may be used to provide a low speed communication link between two wireless devices that are located at each node. In one embodiment, the MC field 196 is a clear channel that does not alter data that it passes to and from the wireless devices.

The PYLD field 198 carries the main payload information. The payload information may be any sort of data including audio data. The amount of data that can be transmitted in the PYLD field 198 may be programmable. In one embodiment, the PYLD field 198 can be sub-divided with the constraints that the data word vary between 2-16 bits, with the number of data words in the payload field being programmable.

The frame structure 190 of the air interface protocol of FIG. 10 supports four different modes: a unidirectional audio mode, a bidirectional audio mode, a bidirectional data mode, and a low-power bidirectional data mode.

The unidirectional audio mode can receive or transport audio samples. Because the mode operates unidirectionally, the communication is in one direction and there are no responses to the transmission of the audio samples. The audio data is transported in the PYLD field 198 of the frame 190, and can be compressed or clear channel.

The bidirectional audio mode provides two-way audio communication between nodes. Therefore, nodes can both transmit and receive audio samples. The audio data is transported in the PYLD field 198 of the frame 190, and can be compressed or clear channel.

The bidirectional data mode provides two-way data communication. The data can be any kind of information, not restricted to audio data, and is transported in the PYLD field 198 of the frame 190. Nodes can transmit and receive because the mode is bidirectional. The data may be clear channel or buffered data.

The low-power bidirectional data mode provides two-way lower power data communication, where the data may be clear channel. In the low-power bidirectional mode, power is conserved when a portion of the transceiver is powered down between bursts (transmissions) to reduce power drain on the device.

During certain modes of operation, the frame 190 may have an additional field. When operating in one of the bidirectional fields, the GT field 192 may be employed. The GT field 192 may be 0-64 bits, and can control the amount of time during which there is no data to be transferred between nodes on the network. This helps to accommodate transport delays, and also prevents frames 190 from colliding with each other.

When in one of the audio modes, there are a limited number of frame sizes that accommodate a given sample rate. Therefore, there are often extra bits left over in a frame 190. These are unused bits, and remain at the end of the frame 190 in the UB field 200.

When the system operates in the low-power bidirectional data mode, there are two additional fields that may be used: a ramp time (RT) field and an asleep time (SLPT) field. The RT field occurs at the beginning of the frame 190, and is used to allow the RF circuitry in the node to stabilize before any data is transferred between nodes. This is necessary because the circuitry is powered down between frame bursts. The SLPT field defines the time during which the wireless device is put into a low power mode between frame bursts.

FIG. 11 is an example frame structure 210 without error control. The frame structure 210 can be further modified depending upon whether or not an error correction scheme is employed. In FIG. 11, n data words are included in the frame, however no additional error checking is included. When an error correction scheme is employed, additional bits or fields may be added to the frame.

FIG. 12 is an example frame structure 220 for a flexible air interface protocol with a cycle redundancy check (CRC) check-sum error protection scheme. In this frame 220, the final field in the frame 220 contains a checksum 222 for the data sent during the current frame.

FIG. 13 is an example frame structure 230 for a flexible air interface protocol with a Hamming-based error correction scheme. With this error correction scheme, Hamming-based parity bits 232 are inserted in the bit stream as shown in FIG. 13. They are calculated every k bits. The payload field is formatted so that k is evenly divisible into n words.

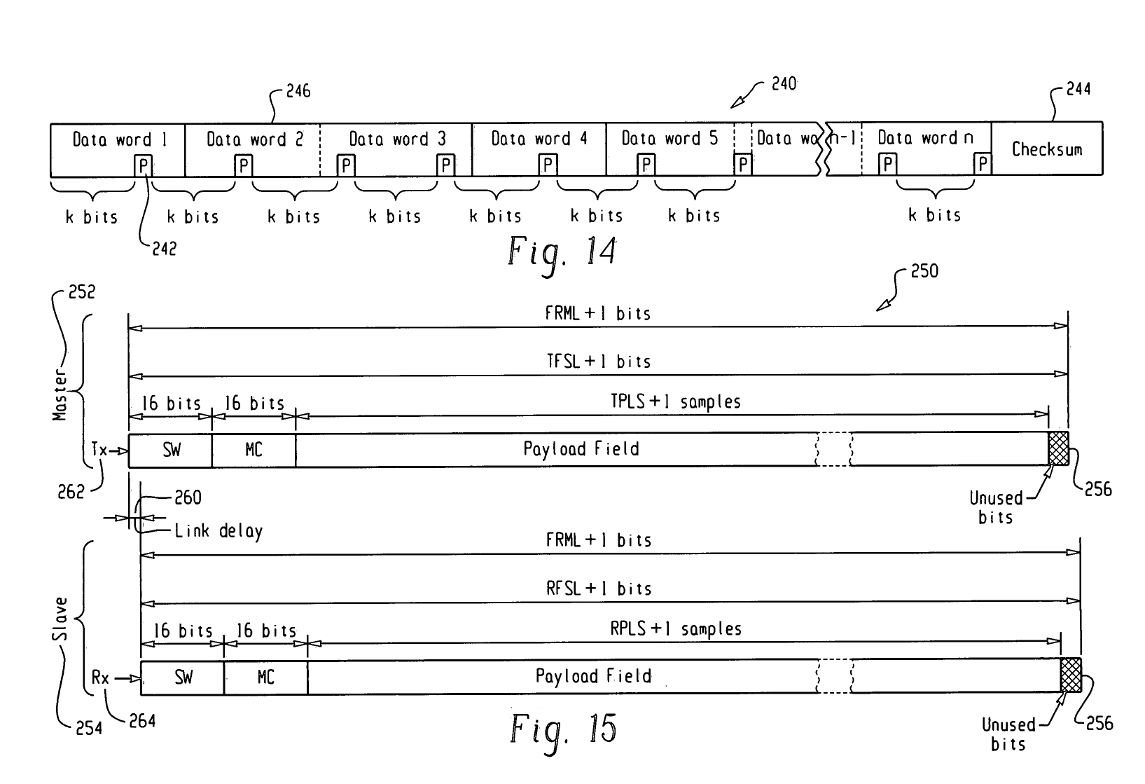

FIG. 14 is an example frame structure 240 for a flexible air interface protocol with a Hamming-based error correction scheme and a CRC. In this example, the CRC checksum 244 is also present in the frame structure 240. The CRC checksum 244 may be calculated using the data words 86, but not the parity bits 242.

The flexibility of the air interface protocol provides additional options for varying the structure of the protocol. In one embodiment, a self-synchronizing scrambler can be used. A self-synchronization scrambler includes a linear feedback shift register (LFSR) that is reset to the state of 0×52 at the start of each frame. The output of the LFSR is then exclusive OR'ed with the raw data to produce scrambled data. The polynomial used in the LFSR is x⁷+x⁶+1. The result is that all of the fields in the frame are scrambled except for the SW field.

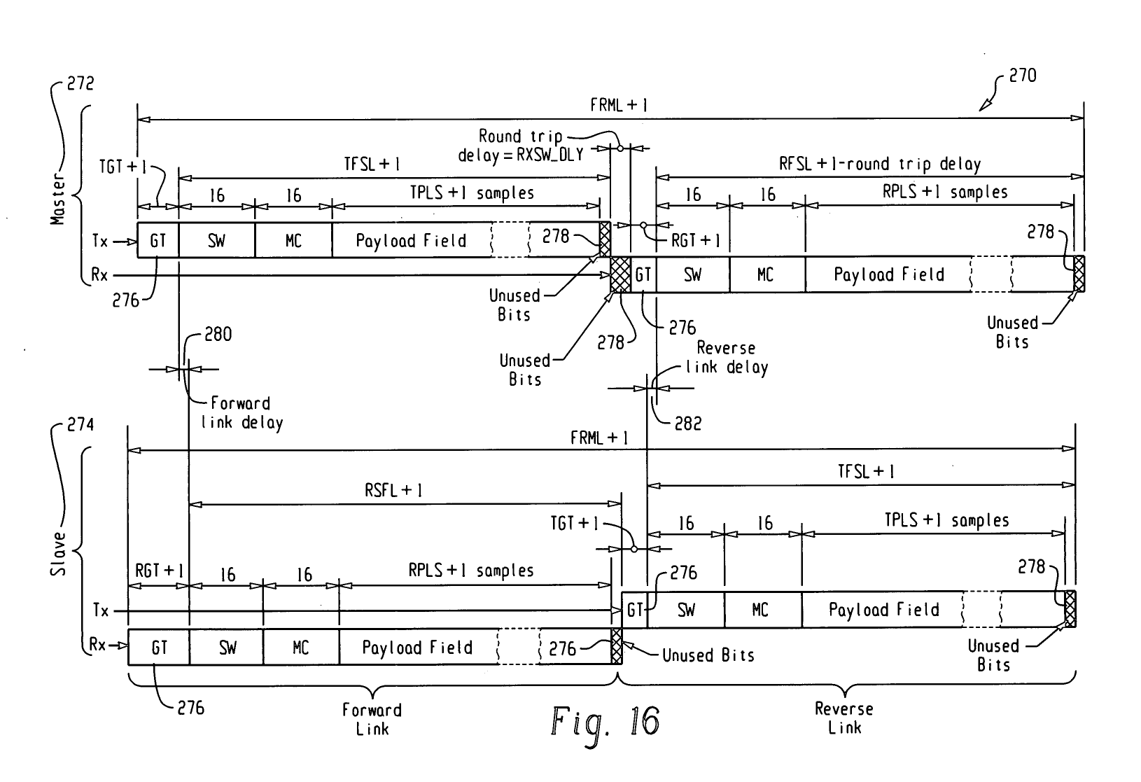

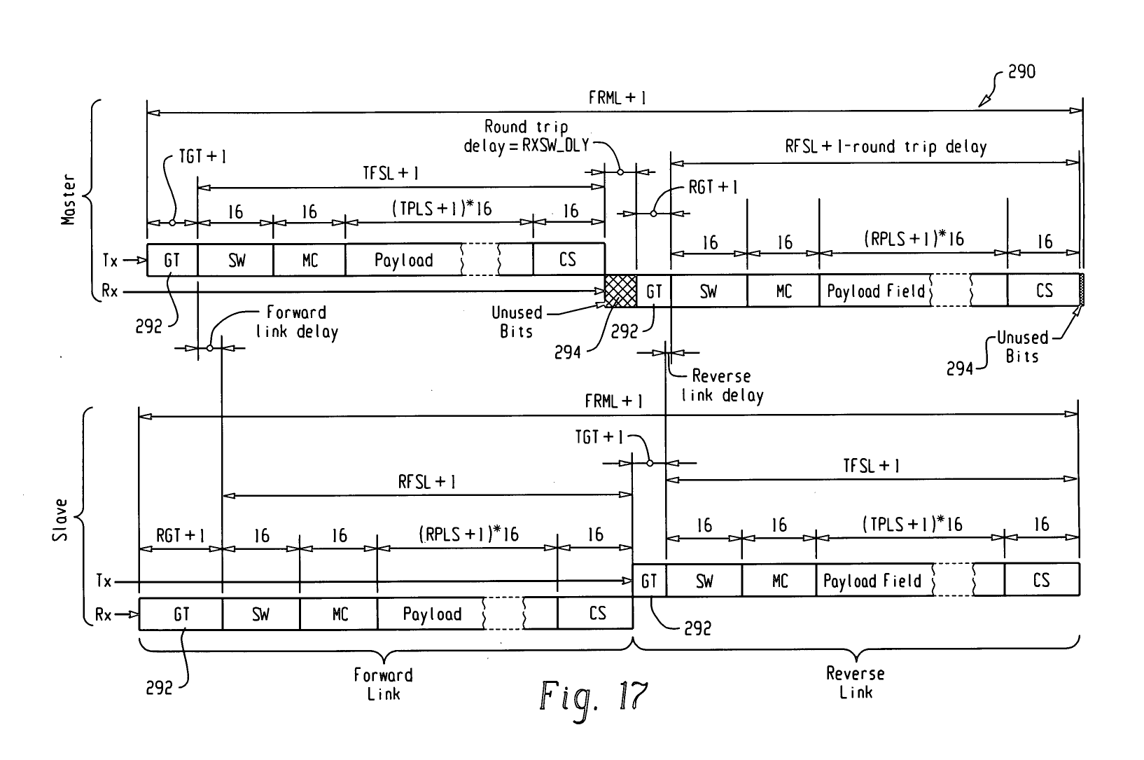

FIG. 15 is an example timing diagram 250 for a transmission using the unidirectional audio mode in an example flexible air interface protocol. There are two diagrams, one indicating the timing for the master node 252 and a second indicating the timing for the slave node 54. The UB field 256 is present in this timing diagram because only audio is being supported. Because there is no switching between transmit and receive modes (the mode is unidirectional), the GT field is not present. The timing diagram 250 demonstrates a small link delay 260 that is present, but the transmitted frame 262 is received by the slave as a received frame 264 immediately following the link delay.

FIG. 16 is an example timing diagram 270 for a bidirectional audio mode in the example flexible air interface protocol. Timing diagrams are shown for both the master node 272 and the slave node 274. With this mode, both the GT 276 and UB 278 fields are used by the master and the slave. The GT field 276 is used because transmissions are bidirectional, and the UB field 278 is used because audio samples are being transmitted.

The GT field 276 accommodates both the forward link delay 280 and the reverse link delay 282. The delays are present for several reasons, including digital re-timing and pipelining, and propagation of the RF transceiver. The UB field 278 accommodates the situation in which not all bits in the payload field are fully utilized. In addition, the UB field 278 may be used in the master receiver to accommodate the uncertainty that occurs in the round trip delay. Although the UB field 278 is shown in both the forward and reverse links, it is possible for the unused bits to be assigned either solely to the forward link or solely to the reverse link.

The bidirectional modes accommodate the finite amount of trip delay. The frame, synchronized in master mode, can accommodate a round trip delay of up to 16 bits. In one example, the round trip delay may be accomodated by first determining the maximum round trip delay (MTRD). Next, the reverse link frame protocol is configured to allow for the MRTD unused bits. Third, the slave RGT should be configured to equal the TGT plus the MRTD. Finally, the slave TFSL should be configured to equal the master RFSL minus the MRTD.

Once the master and slave transceivers are synchronized, the master's receiver should have locked into the SW pattern and adjusted its internal state machines to extract the appropriate fields. A portion of the unused bits assigned to the reverse link may occur ahead of the master receiver's GT. This is the round trip delay, which can be recorded in a register.

FIG. 17 is an example timing diagram 290 for a bidirectional data mode in the example flexible air interface protocol. In this mode, the slave node may only use the GT field 292, and the master node may use both the GT field 292 and the UB field 294. The GT field 292 accommodates the switching between transmit and receive, and also accomodates the forward and reverse link delays. The UB field 294 is used in the master receiver to accommodate the uncertainty in the round trip delay.

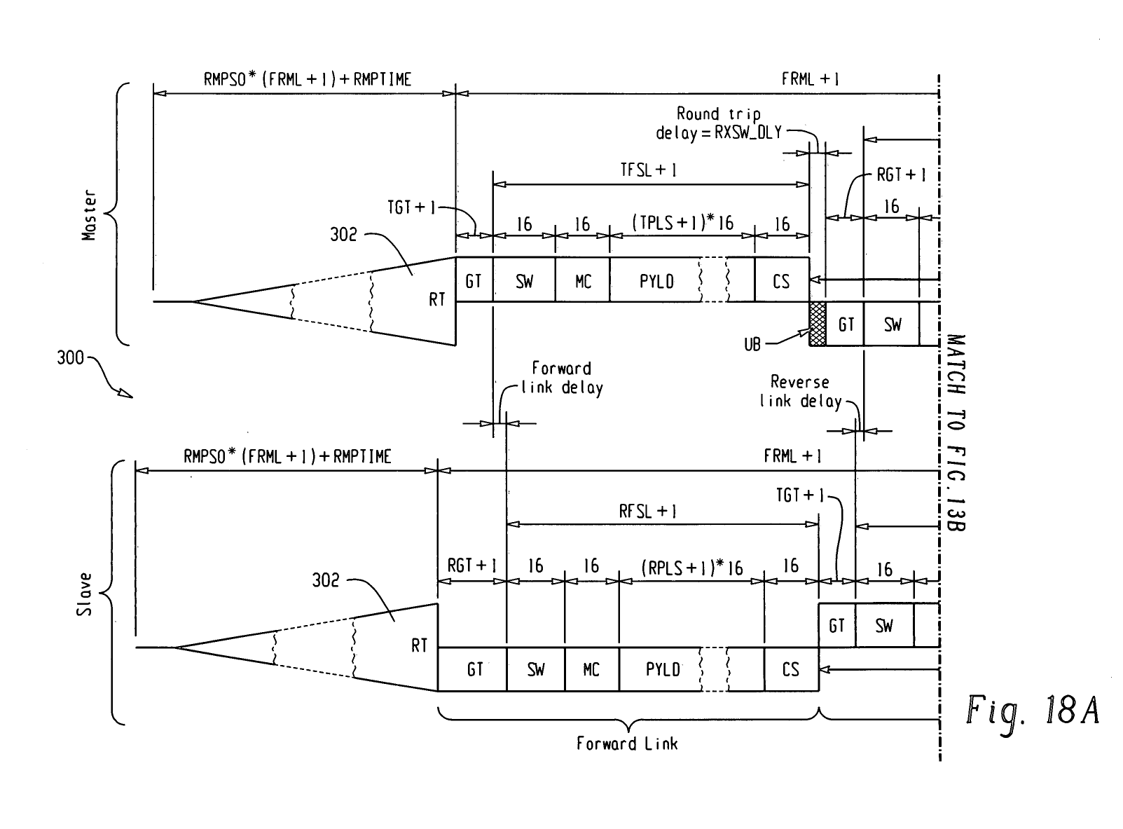

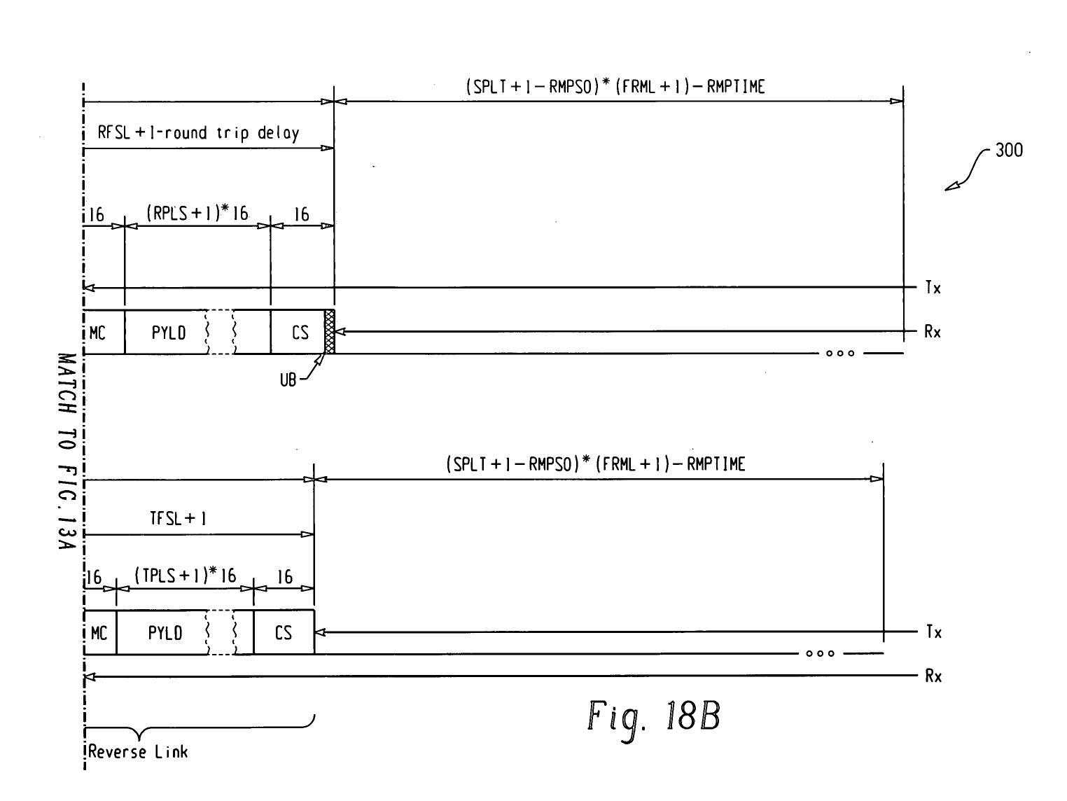

FIG. 18 is an example timing diagram 300 for a low-power bidirectional data mode in the example flexible air interface protocol. This mode may be viewed as a special case of the bidirectional data mode, with the variation that the nodes on the network are put into a low power mode for a portion of the frame. This is achieved using two additional fields, Ramp Time (RT) 302 and Asleep Time (SLPT). Once synchronization is established, the nodes will be in the RT 302 and SLPT phases at the same time.

The flexible wireless air interface disclosed herein provides a flexible yet low power wireless protocol in which the framing overhead is low and latency can be minimized by selecting short frame sizes. The protocol disclosed herein may be used in a variety of electronic devices or clients, such as body-worn appliances. The protocol may also facilitate future expansion and allows for multiple configurations per client.

This written description used examples to disclose the invention, including the best mode, and also to enable a person skilled in the art to make and use the invention. The patentable scope of the invention may include other examples that occur to those skilled in the art. For example, the RF communication module described herein may instead be incorporated in devices other than a hearing instrument or base unit, such as a wireless headset, a communication ear-bud, a body worn control device, or other communication devices.

What is claimed is:

1. A wireless hearing instrument system, comprising:
a hearing instrument including communications circuitry for wirelessly receiving a signal from a remote transmitter, the hearing instrument being operable to process the signal to compensate for a hearing impairment of a hearing instrument user and to transmit the processed audio signal into an ear canal of the hearing instrument user;
the received signal being formatted in an air interface protocol that includes:
a frame synchronization word field to delineate the start of a frame structure;
an out-of-band message channel field to provide a low speed communication link between the remote transmitter and the wireless hearing instrument; and
a configurable payload field to carry main payload information.

2. The wireless hearing instrument system of claim 1, wherein the remote circuitry is configured to transmit data in a plurality of modes, the plurality of modes including,
a first mode that provides unidirectional communication to transport audio samples;
a second mode that provides bidirectional communication to transport audio samples;
a third mode that provides bidirectional communication to transport data; and
a fourth mode that provides bidirectional communication to provide low-power data communication.

3. The wireless hearing instrument system of claim 1, wherein the remote transmitter is included in another wireless hearing instrument.

4. The wireless hearing instrument system of claim 1, wherein the remote transmitter is a wireless base unit.

5. The wireless hearing instrument system of claim 1, where the remote transmitter is a wireless microphone.

6. The wireless hearing instrument system of claim 1, wherein the frame synchronization word field is programmable.

7. The wireless hearing instrument system of claim 1, wherein the out-of-band message channel field is a 16-bit field.

8. The wireless hearing instrument system of claim 1, wherein the out-of-band message channel field is a clear channel and passes data to and from the plurality of processors without the data being altered.

9. The wireless hearing instrument system of claim 1, wherein the payload information is non-audio data.

10. The wireless hearing instrument system of claim 1, wherein the size of the configurable payload field is programmable.

11. The wireless hearing instrument system of claim 1, further comprising a guard time field to control the amount of time when there is no data transferred to and from the plurality of processors.

12. The wireless hearing instrument system of claim 8, wherein the guard time field is active in second mode, the third mode, and the fourth mode.

13. The wireless hearing instrument system of claim 1, further comprising unused bits.

14. The wireless hearing instrument system of claim 1, further comprising:
a ramp time field to allow RF circuitry to stabilize before data is transferred to and from the plurality of processors; and
an asleep time field to define the time in which one of the plurality of processors is put into a low power mode.

15. The wireless hearing instrument system of claim 2, wherein the ramp time field and the asleep time field are active in the fourth mode.

16. The wireless hearing instrument system of claim 1, wherein the payload field data word length can vary between 2 and 16 bits.

17. The wireless hearing instrument system of claim 1, wherein a number of data words in the payload field is programmable.

18. The wireless hearing instrument system of claim 1, further comprising a cycle redundancy check check-sum error protection scheme.

19. The wireless hearing instrument of claim 1, further comprising a Hamming-based error correction scheme.

20. The wireless hearing instrument of claim 18, further comprising a Hamming-based error correction scheme.

21. The wireless hearing instrument of claim 14, wherein the RF circuitry is placed in a low-power mode for a portion of the frame.

22. The wireless hearing instrument of claim 14 wherein the main payload information is audio signal data.

23. A wireless hearing instrument system, comprising:
a first hearing instrument including one or more microphones for generating a signal and including communications circuitry for wirelessly transmitting the signal; and
a second hearing instrument including communications circuitry for receiving the signal from the first hearing instrument,
the communications circuitry being configured to operate in a plurality of modes, the framing structure configured to be common for the plurality of modes, the plurality of modes comprising:
a first mode providing unidirectional communication to transport audio samples;
a second mode providing bidirectional communication to transport audio samples;
a third mode providing bidirectional communication to transport data; and
a fourth mode providing bidirectional communication to provide low-power data communication.

24. The wireless hearing instrument system of claim 23, wherein the framing structure configured to be common for the plurality of modes comprises a frame synchronization word field, an out-of-band message channel field and a configurable payload field.

25. The wireless hearing instrument system of claim 24, wherein the framing structure configured to be common for the plurality of modes is programmable.

26. The wireless hearing instrument system of claim 24, wherein the framing structure configured to be common for the plurality of modes further comprises a guard time field.

27. The wireless hearing instrument system of claim 24, wherein the framing structure configured to be common for the plurality of modes further comprises an unused bits field.

28. The wireless hearing instrument system of claim 24, wherein the framing structure configured to be common for the plurality of modes further comprises a ramp time field.

29. The wireless hearing instrument system of claim 24, wherein the framing structure configured to be common for the plurality of modes further comprises an asleep time field.

30. A memory for storing data for use in a hearing-related process, comprising a framing data structure, the framing data structure having a frame synchronization word field, an out-of-band message channel field, and a configurable payload field,
the frame synchronization word field delineating the start of the frame structure;
the out-of-band message channel field providing a low speed communication link between a plurality of processors attached to wireless devices; and
the configurable payload field to carry main payload information;
the framing data structure being configured to transmit data in a plurality of modes, the plurality of modes comprising:
a first mode providing unidirectional communication to transport audio samples;
a second mode providing bidirectional communication to transport audio samples;
a third mode providing bidirectional communication to transport data; and
a fourth mode providing bidirectional communication to provide low-power data communication.
